(19) United States
(12) Patent Application Publication
(10) Pub. No.: US 2014/0273716 A1
(43) Pub. Date: Sep. 18, 2014

(54) Perceived Opacity Smart Toy

(71) Applicants: Robert Annis, Park Ridge, IL (US); Donald Rosenwinkel, Oak Park, IL (US)

(72) Inventors: Robert Annis, Park Ridge, IL (US); Donald Rosenwinkel, Oak Park, IL (US)

(21) Appl. No.: 13/829,437

(22) Filed: Mar. 14, 2013

(51) Int. Cl. A63H 3/36; G09B 5/06; A63H 30/02

(52) U.S. Cl. CPC A63H 3/36; A63H 30/02; G09B 5/06
USPC 446/175

(57) ABSTRACT

A perceived opacity smart play system or toy that uses a special cover that is partially opaque around a smart device having a capacitive touch-screen. The smart device is housed behind a material that appears opaque until the screen on the device is illuminated. This illumination allows an image on the screen to be seen through the opaque appearing material. This allows a child to learn and interact by means of the smart device's touch screen, microphone, tilt switch, accelerometer and vibrating motor. The system can be supplied with an APP that can be loaded onto the phone. Various letters, images, words, etc. can appear through the cover and prompt various responses of touching, tilting, and speaking to signal a correct answer. The system can then laugh and vibrate in response before prompting for more play.

### BACKGROUND

1. Field of the Invention

The present invention relates generally to smart toys and more particularly to a perceived opacity smart device toy with a special type of cover.

2. Description of the Prior Art

With the advent of physically small handheld devices such as smartphones and tablets, considerable computing power can be carried in the hand or pocket. In particular, smartphones and tablets can download, or be loaded, with numerous different applications (APPS). The use of a smartphones, tablets and other smart devices as toys or entertainment devices has gained popularity.

Because smartphones and tablets come equipped with numerous physical features and sensors such as accelerometers, GPS, and touch sensitive screens, and because smartphone and tablet platforms provide interfaces for APPS to access these features, it would be very advantageous to have a toy, educational doll or plush that contained a smartphone or tablet with one or more special applications (APPS) and a unique system that catches and maintains a child's attention while allowing them to learn by interacting with and manipulating the device's touch screen, microphone, tilt switch, accelerometer and vibrating motor. This type of toy or doll can help children learn numbers, letters, colors, words and the like through their play. The child could also be able to play simple games with the figure as directed by the device.

### SUMMARY OF THE INVENTION

The present invention relates to a perceived opacity smart toy that uses a special cover that is partially opaque. The interactive toy uses a capacitive or other touch-screen display equipped mobile device that is housed behind a material that appears opaque until the screen on the device is illuminated. This illumination allows an image on the screen to be seen through the opaque appearing material. The perceived opacity is created by placing a very fine mesh such as a scrim-like material, or a one way mirror, in front of the screen. When the screen is not illuminated, the ambient light of the room reflects off the front surface of the material and appears opaque. When the device's screen is illuminated, the image projected on the screen shines through the scrim making it visible. The scrim is typically made of a material that is thin enough to allow the capacitance of the operator to be read or sensed when the translucent material covering its surface is touched.

Another embodiment is an interactive doll or other shape that displays a smartphone through its partially opaque t-shirt or garment (via an internal pocket) which allows a child to learn and interact by means of the device's touch screen, microphone, tilt switch, accelerometer and vibrating motor. The toy can be supplied with an APP that would be loaded onto the device. Various letters, images, words, etc. would appear through the shirt and prompt various responses of touching, tilting, and speaking to signal a correct answer. The toy can then laugh and vibrate in response before prompting for more play.

### DESCRIPTION OF THE FIGURES

Attention is now directed to several drawings that illustrate features of the present invention:

FIG. 1 shows a smartphone with a partially opaque cover.

FIG. 2 shows a side view of transmitted and reflected rays.

FIG. 3 shows an embodiment of the invention in a doll.

FIG. 4 shows the embodiment of FIG. 3 with a closed pocket.

Several drawings and illustrations have been presented to aid in understanding the present invention. The scope of the present invention is not limited to what is shown in the figures.

### DESCRIPTION OF THE PREFERRED EMBODIMENTS

The present invention relates to perceived opacity smart toy that uses a special cover or screen that is partially opaque. The interactive toy uses a capacitive touch-screen display equipped mobile device that is housed behind a material that appears opaque until the screen on the device is illuminated. A capacitive touch screen is preferred as opposed to a resistive or SAW touch technology because the present invention requires the screen to work at a slightly increased distance from the glass. The touch screen must be able to sense the finger or hand through the semi-opaque material. While a capacitive touch screen is preferred, any screen that can sense the presence of a finger through a scrim or cover is within the scope of the present invention. Also, any semi-opaque material that will allow a touch screen to respond is within the scope of the present invention.

FIG. 1 shows a diagram of a smartphone 1 behind a partially opaque screen 2. When the touch screen on the smartphone 3 is illuminated, an image 4 appears on the surface of the partially opaque material. The partially opaque material can be in the shape of a phone-cover, a bag or sack, a pocket or any other shape that can contain the smartphone or other smart device. When the device is used with a doll or other toy, it is preferred to include a closable pocket on the doll or toy that holds the smart device securely while at the same time allowing the opaque outer side to fit fairly snugly against the touch screen of the device. This pocket can be closed with tape, VELCRO™, a zipper, or by any other closing technique. Generally such a pocket is necessary so that the smart device can be removed for charging, cleaning or the like. It is also preferred that the pocket be closed in some fashion to prevent the smart device from falling out during play, or if the toy is thrown or dropped.

The partially opaque material acts as an optical screen and can be made from very fine mesh or a scrim-like material. Scrims are used extensively in theater for a variety of special effects. These are sometimes called “sharkstooth scrim”. Any thin screen or screen-like structure is within the scope of the present invention. Scrims generally have a rectangular weave tighter than the size of the openings in a window screen. The screen 2 must be thin enough that when it is close to the smart device screen, the illuminated image on the smart device can be seen through it. As stated, the screen 2 must also allow the capacitive touch-screen on the smart device to function when the child touches the surface. The image on the surface of the screen thus takes on a phantom-like appearance immediately capturing the attention of the child. The scrim material or screen provides enough incident visible light scattering and reflection to make it appear opaque, but enough absorption so that reflected incident light from a dark LCD behind it is not visible. The scrim material is thin and porous so that it has high transmissivity. The loss of LCD contrast due to the absorption in the scrim material must be low enough for the display to still be readable. The scrim typically is non-conductive, and pressed against the touch screen glass. This maintains enough capacitive coupling from a finger to the touch screen to allow the screen to detect a touch.

The smartphone 1 can be supplied with a custom APP that allows the child to manipulate the tilt switch, accelerometers and/or other sensors that might be found in the smartphone. In particular, the child can speak to the APP which can occur through the smartphone's microphone. The phone can then respond to the child using its speaker. The APP can cause the sounds of laughter and turn a figure to respond to touching by the child such as tickling. The APP can cause various letters, images and words to appear to prompt various responses from the child such as rotating, tilting and speaking to signal a correct answer as well as vibrating and making various noises or by playing music. The APP can be supplied with the screen for use with various commercially available smartphone and smart device platforms, or it can be downloaded from the Internet.

FIG. 2 shows a side view of direct and transmitted light rays. The screen 5 is typically partially reflective and partially transmissive as has been stated. When one side of the screen is brightly lit, and the other side is dark, the screen allows viewing from the darkened side, but not vice versa. The screen 5 can be positioned in front of the smartphone 1 so that light from the phone 6 passes through the screen, but ambient light 7 is mostly reflected. Also ambient light reflecting off of the LCD or touch screen glass is mostly attenuated 8 by two trips through the screen.

The screen depicted in FIG. 2 can be in an alternate embodiment a one-way mirror 5. If a one-way mirror is used, it should be such a material that also allows the child to interact with the capacitive touch screen on the smartphone. A mirror surface that adversely affects the smartphone's ability to sense touch could cause the system to not work.

FIG. 3 shows a preferred embodiment of the present invention. A smartphone 1 is slipped into a pocket 10 on the inside of a garment 8 that can be worn by a doll 9 as previously described. The pocket can be sized to fit the device snugly or contain a closure mechanism such as VELCRO™ straps or other fasteners 11 to hold the device securely in place. The garment (or t-shirt) 8 functions as a partially opaque screen. Again, the APP in the phone can be programmed to respond to the child's touch, the position of the doll, movement like rotating, shaking and the like. This embodiment of the invention can have any or all of the features of the other embodiments. The APP can laugh if the surface is tickled and can make various noises if the doll is dropped, turned sideways or upside down, or different noises if the doll is shaken. The APP can ask questions of the child and display various letters, words or symbols.

FIG. 4 shows the embodiment of FIG. 3 with a pocket 10 closed by a strip 11.

The toy of the present invention can engage a child and be educational by presenting letters or words and asking for responses. Various replies can be given for correct or wrong answers. The toy can also laugh and/or vibrate in response before prompting for more play. A plush doll also servers to protect the smartphone or smart device.

One or more APPs can be written for use with the present invention using the ANDROID™ platform or the iPhone™ platform using software design platforms (SDKs) and application interfaces (API) known in the art. APPs can also be written in HTML5 and other languages for any type of smart device. These APPs can be wirelessly downloaded as is well-known in the art. As previously described, the APPs can be tailored for particular age ranges, particular educational or learning goals and for different embodiments of the invention such as with dolls, bags, mittens, bed sheets pajamas with pockets or any other use where a smart device can be placed behind a semi-opaque cover.

Several descriptions and illustrations have been given to aid in understanding the present invention. One with skill in the art will realize that numerous changes and variations can be made without departing from the spirit of the device. Each of these changes and variations is within the scope of the present invention.

We claim:

1. An interactive play toy comprising:
a partially opaque cover or pocket adapted to receive and contain a smart device;
a custom application adapted to be loaded onto said smart device, wherein said application is adapted to interact with a child through sensors on the smart device and to present a plurality of different displays to the child through said partially opaque cover.

2. The interactive play toy of claim 1 adapted so that when said smart device is off, the partially opaque cover appears dark, and when said smart device is turned on, light immediately appears through said partially opaque cover.

3. The interactive play toy of claim 1 wherein said application is adapted to cause the smart device to present a plurality of sounds or images to the child in response to stimulus to a touch-sensitive screen on the smart device, and to rotating, tilting or accelerating the smart device.

4. The interactive play toy of claim 1 wherein said partially opaque cover is a scrim.

5. The interactive play toy of claim 1 wherein said partially opaque cover is a screen with a substantially rectangular mesh.

6. The interactive play toy of claim 1 wherein said partially opaque cover is a one-way mirror.

7. The interactive play toy of claim 1 wherein said application is adapted to cause a plurality of letters, images, words or symbols to appear on the smart device's screen.

8. The interactive play toy of claim 1 wherein said application is adapted to speak to the child and interpret voice responses from the child.

9. The interactive play toy of claim 8 wherein said application is adapted to cause the smart device vibrate according to said voice responses from the child.

10. The interactive play toy of claim 8 wherein said application is adapted to produce audible laughter or verbal responses according to said voice responses from the child.

11. The interactive toy of claim 1 wherein said cover is part of a closable pocket.

12. An interactive educational play device comprising:
a partially opaque mesh cover adapted to receive and contain a smartphone;
a custom application adapted to be loaded onto said smartphone, wherein said application is adapted to interact with a child through sensors on the smartphone and to present a plurality of different displays to the child through said partially opaque cover; and,
wherein said application is adapted to cause the smartphone to present a plurality of sounds or images to the child in response to stimulus to a touch-sensitive screen on the smartphone, and to tilting or accelerating the smartphone.

13. The interactive educational play device of claim 12 wherein said application is adapted to speak to the child and interpret a voice response from the child.

14. The interactive educational play device of claim 13 wherein said application is adapted to cause the smartphone vibrate according to said voice response.

15. The interactive educational play device of claim 13 wherein said application is adapted to produce audible laughter or verbal responses according to said voice response.

16. The interactive educational play device of claim 12 wherein said partially opaque mesh cover is part of a t-shirt.

17. A method for helping a child to learn numbers, letters, colors and words comprising:
placing a smart device in a partially opaque cover;
providing a custom application for said smart device;
wherein said custom application is adapted to interact with a child through sensors on the smart device and to present a plurality of different displays to the child through said partially opaque cover; and,
wherein said custom application is adapted to speak to the child and interpret a voice responses from the child.

18. The method of claim 17 wherein said application is adapted to cause the smart device vibrate according to said voice responses.

19. The method of claim 17 wherein said application is adapted to produce audible laughter according to said voice responses.

20. The method of claim 17 wherein said partially opaque mesh cover is part of a pocket.
